(19) United States
(12) Patent Application Publication
(10) Pub. No.: US 2025/0315480 A1
(43) Pub. Date: Oct. 9, 2025

(54) DIRECTED GRAPH LAYOUT METHOD AND APPARATUS FOR PROCESS EDITING

(71) Applicant: Beijing Volcano Engine Technology Co., Ltd., Haidian District (CN)

(72) Inventor: Yilin QIU, Beijing (CN)

(21) Appl. No.: 19/061,050

(22) Filed: Feb. 24, 2025

(30) Foreign Application Priority Data
Apr. 9, 2024 (CN) 202410424215.X

(51) Int. Cl. G06F 16/901

(52) U.S. Cl. CPC G06F 16/9024

(57) ABSTRACT

A directed graph layout method suitable for process editing is disclosed in the present application. The method includes: obtaining first node information of a first directed graph to be laid out, the first directed graph including a plurality of nodes, and the first node information including: node information corresponding to each of the plurality of nodes, where: for any node of the plurality of nodes, the node information corresponding to the node is used to indicate a child node included in the node, and if the node includes a plurality of child nodes, the node information corresponding to the node is further used to indicate an order between the plurality of child nodes; determining a first hierarchy corresponding to each of the plurality of nodes according to the first node information.

### CROSS-REFERENCE TO RELATED APPLICATION(S)

This application claims priority to Chinese Application No. 202410424215.X filed on Apr. 9, 2024, the disclosure of which is incorporated herein by reference in its entirety.

### FIELD

The present application relates to the field of data processing, and in particular, to a directed graph layout method and apparatus for process editing.

### BACKGROUND

A directed graph is a graph structure composed of nodes and directed edges, which has a strong process expression capability. Directed graphs are generally used to display workflows, state transitions, and the like. In addition, since the directed graph has a hierarchy characteristic similar to a tree graph, the directed graph is also widely used in genealogy, version management and other fields.

The node coordinates can be calculated by using the directed graph layout algorithm, and the directed graph can be visually displayed based on the node coordinates.

### SUMMARY

In order to solve or at least partially solve the above technical problems, embodiments of the present application provide a directed graph layout method and apparatus for process editing.

In a first aspect, an embodiment of the present application provides a directed graph layout method for process editing, the method includes:
obtaining first node information of a first directed graph to be laid out, the first directed graph including a plurality of nodes, and the first node information including: node information corresponding to each of the plurality of nodes, wherein: for any node of the plurality of nodes, the node information corresponding to the node is used to indicate a child node included in the node, and if the node includes a plurality of child nodes, the node information corresponding to the node is further used to indicate the order between the plurality of child nodes;
determining a first hierarchy corresponding to each of the plurality of nodes according to the first node information; and
determining a layout position of each node based on the first hierarchy corresponding to each node and the first node information.

Optionally, the plurality of nodes includes a virtual root node, the virtual root node being used as a virtual parent node of a first-level node, and determining a first hierarchy corresponding to each node of the plurality of nodes according to the first node information includes:
traversing the first node information from the virtual parent node, to access the nodes included in the first node information, and determine a first hierarchy corresponding to the respective accessed nodes.

Optionally, the plurality of nodes includes a first node, and the method further includes:
if the first node is accessed a plurality of times, and the hierarchy determined for the first node based on the plurality of times of accessing the first node is different, taking a largest hierarchy for the first node determined based on the plurality of times of accessing as the first hierarchy of the first node.

Optionally, determining a layout position of each node based on the first hierarchy corresponding to each node and the first node information includes:
if the first hierarchy of respective parent node of the plurality of nodes and the first hierarchy of a child node corresponding to the parent node are continuous, determining the layout position of each node based on the first hierarchy corresponding to each node and the first node information.

Optionally, determining a layout position of each node based on the first hierarchy corresponding to each node and the first node information includes:
if the first hierarchy of a first parent node of the plurality of nodes and the first hierarchy of a first child node of the plurality of nodes are discontinuous, inserting a virtual node between the first parent node and the first child node, wherein the first parent node is a parent node of the first child node, and the virtual node is used to determine a trend of a line segment between the first parent node and the first child node;
updating the first node information based on the virtual node to obtain second node information, wherein the second node information comprises node information respectively corresponding to each node and information of the virtual node;
determining a second hierarchy corresponding to each of the plurality of nodes and a second hierarchy corresponding to the virtual node according to the second node information; and
determining the layout position of each node based on the second hierarchy corresponding to each node, the second hierarchy corresponding to the virtual node, and the second node information.

Optionally, obtaining the first node information of the first directed graph includes:
in response to a node edit operation triggered for a displayed second directed graph, determining node information that has changed caused by the node edit operation; and
updating third node information based on the node information that has changed to obtain the first node information, wherein the third node information is node information corresponding to the second directed graph, and the third node information includes node information corresponding to respective nodes in the second directed graph.

Optionally, in response to the node edit operation triggered for the second directed graph, determining the node information that has changed caused by the node edit operation includes:
in response to a parent node insert operation triggered for a second node in the second directed graph, determining that the node information that has changed caused by the parent node insert operation includes: node information of a parent node of the second node included in the third node information, and node information of a node inserted by the parent node insert operation; and
updating the third node information based on the node information that has changed to obtain the first node information includes:
modifying the node information of the parent node of the second node included in the third node information, and adding the node information of the node inserted by the parent node insert operation to the third node information to obtain the first node information.

Optionally, in response to the node edit operation triggered for the second directed graph, determining the node information that has changed caused by the node edit operation includes:
in response to a child node insert operation triggered for a second node in the second directed graph, determining that the node information that has changed caused by the child node insert operation includes: node information of the second node included in the third node information, and node information of a node inserted by the child node insert operation; and
updating the third node information based on the node information that has changed to obtain the first node information includes:
modifying the node information of the second node included in the third node information, and adding the node information of the node inserted by the child node insert operation to the third node information to obtain the first node information.

Optionally, in response to the node edit operation triggered for the second directed graph, determining the node information that has changed caused by the node edit operation includes:
in response to a sibling node insert operation triggered for a second node in the second directed graph, determining that the node information that has changed caused by the sibling node insert operation includes: node information of a parent node of the second node included in the third node information, and node information of a node inserted by the sibling node insert operation; and
updating the third node information based on the node information that has changed to obtain the first node information includes:
modifying the node information of the parent node of the second node included in the third node information, and adding the node information of the node inserted by the sibling node insert operation to the third node information to obtain the first node information.

Optionally, in response to the node edit operation triggered for the second directed graph, determining the node information that has changed caused by the node edit operation includes:
in response to a node delete operation triggered for a third node in the second directed graph, determining that the node information that has changed caused by the node delete operation includes: node information of a parent node of the third node included in the third node information, and node information of the third node; and
updating the third node information based on the node information that has changed to obtain the first node information includes:
deleting the node information of the third node included in the third node information, and deleting the third node from the node information of the parent node of the third node to obtain the first node information.

Optionally, in response to the node edit operation triggered for the second directed graph, determining the node information that has changed caused by the node edit operation includes:
in response to a position move operation triggered for a fourth node in the second directed graph, determining that the node information that has changed caused by the position move operation includes: first change information and second change information, wherein the first change information includes: node information that has changed caused by triggering a delete of the fourth node for the second directed graph, and the second change information includes: node information that has changed caused by inserting the fourth node into the second directed graph from which the fourth node is deleted.

In a second aspect, an embodiment of the present application provides a directed graph layout apparatus for process editing, the apparatus includes:
an obtaining unit, configured to obtain first node information of a first directed graph to be laid out, the first directed graph including a plurality of nodes, and the first node information including: node information corresponding to each of the plurality of nodes, where: for any node of the plurality of nodes, the node information corresponding to the node is used to indicate a child node included in the node, and if the node includes a plurality of child nodes, the node information corresponding to the node is further used to indicate an order between the plurality of child nodes;
a first determination unit, configured to determine a first hierarchy corresponding to each of the plurality of nodes according to the first node information; and
a second determination unit, configured to determine a layout position of each node based on the first hierarchy corresponding to each node and the first node information.

Optionally, the plurality of nodes includes a virtual root node, the virtual root node being used as a virtual parent node of a first-level node, and the first determination unit is configured to:
traverse the first node information from the virtual parent node, to access the nodes included in the first node information, and determine a first hierarchy corresponding to the respective accessed nodes.

Optionally, the plurality of nodes includes a first node, and the apparatus further includes:
a third determination unit, configured to: if the first node is accessed a plurality of times, and the hierarchy determined for the first node based on the plurality of times of accessing the first node is different, take a largest hierarchy for the first node determined based on the plurality of times of accessing as the first hierarchy of the first node.

Optionally, the second determination unit is configured to:
if the first hierarchy of respective parent node of the plurality of nodes and the first hierarchy of a child node corresponding to the parent node are continuous, determine the layout position of each nodes based on the first hierarchy corresponding to each node and the first node information.

Optionally, the second determination unit is configured to:
if the first hierarchy of a first parent node of the plurality of nodes and the first hierarchy of a first child node of the plurality of nodes are discontinuous, inserting a virtual node between the first parent node and the first child node, wherein the first parent node is a parent node of the first child node, and the virtual node is used to determine a trend of a line segment between the first parent node and the first child node;
updating the first node information based on the virtual node to obtain second node information, wherein the second node information comprises node information respectively corresponding to each node and information of the virtual node;
determining a second hierarchy corresponding to each of the plurality of nodes and a second hierarchy corresponding to the virtual node according to the second node information; and
determining the layout position of each node based on the second hierarchy corresponding to each node, the second hierarchy corresponding to the virtual node, and the second node information.

Optionally, the obtaining unit is configured to:
in response to a node edit operation triggered for a displayed second directed graph, determining node information that has changed caused by the node edit operation; and
updating third node information based on the node information that has changed to obtain the first node information, wherein the third node information is node information corresponding to the second directed graph, and the third node information includes node information corresponding to respective nodes in the second directed graph.

Optionally, in response to the node edit operation triggered for the second directed graph, determining the node information that has changed caused by the node edit operation includes:
in response to a parent node insert operation triggered for a second node in the second directed graph, determining that the node information that has changed caused by the parent node insert operation includes: node information of a parent node of the second node included in the third node information, and node information of a node inserted by the parent node insert operation; and
updating the third node information based on the node information that has changed to obtain the first node information includes:
modifying the node information of the parent node of the second node included in the third node information, and adding the node information of the node inserted by the parent node insert operation to the third node information to obtain the first node information.

Optionally, in response to the node edit operation triggered for the second directed graph, determining the node information that has changed caused by the node edit operation includes:
in response to a child node insert operation triggered for a second node in the second directed graph, determining that the node information that has changed caused by the child node insert operation includes: node information of the second node included in the third node information, and node information of a node inserted by the child node insert operation; and
updating the third node information based on the node information that has changed to obtain the first node information includes:
modifying the node information of the second node included in the third node information, and adding the node information of the node inserted by the child node insert operation to the third node information to obtain the first node information.

Optionally, in response to the node edit operation triggered for the second directed graph, determining the node information that has changed caused by the node edit operation includes:
in response to a sibling node insert operation triggered for a second node in the second directed graph, determining that the node information that has changed caused by the sibling node insert operation includes: node information of a parent node of the second node included in the third node information, and node information of a node inserted by the sibling node insert operation; and
updating the third node information based on the node information that has changed to obtain the first node information includes:
modifying the node information of the parent node of the second node included in the third node information, and adding the node information of the node inserted by the sibling node insert operation to the third node information to obtain the first node information.

Optionally, in response to the node edit operation triggered for the second directed graph, determining the node information that has changed caused by the node edit operation includes:
in response to a node delete operation triggered for a third node in the second directed graph, determining that the node information that has changed caused by the node delete operation includes: node information of a parent node of the third node included in the third node information, and node information of the third node; and
updating the third node information based on the node information that has changed to obtain the first node information includes:
deleting the node information of the third node included in the third node information, and deleting the third node from the node information of the parent node of the third node to obtain the first node information.

Optionally, in response to the node edit operation triggered for the second directed graph, determining the node information that has changed caused by the node edit operation includes:
in response to a position move operation triggered for a fourth node in the second directed graph, determining that the node information that has changed caused by the position move operation includes: first change information and second change information, wherein the first change information includes: node information that has changed caused by triggering a delete of the fourth node for the second directed graph, and the second change information includes: node information that has changed caused by inserting the fourth node into the second directed graph from which the fourth node is deleted.

In a third aspect, an embodiment of the present application provides an electronic device, the device includes a processor and a memory;
the processor is configured to execute instructions stored in the memory, to cause the device to perform the method according to any of the first aspect above.

In a fourth aspect, an embodiment of the present application provides a computer-readable storage medium, including instructions, where the instructions instruct a device to perform the method according to any of the first aspect above.

In a fifth aspect, an embodiment of the present application provides a computer program product, when the computer program product is run on a computer, causing the computer to perform the method according to any of the first aspect above.

### BRIEF DESCRIPTION OF THE DRAWINGS

In order to more clearly explain the technical solutions in the embodiments of the present application or in the prior art, the drawings required in describing the embodiments or the prior art will be briefly introduced below. Obviously, the drawings in the following description are only some embodiments recorded in the present application, and those skilled in the art can obtain other drawings according to these drawings without creative efforts.

FIG. 1 is a schematic flowchart of a directed graph layout method for process editing provided by an embodiment of the present application;

FIG. 2 is a schematic flowchart of a method for obtaining first node information provided by an embodiment of the present application;

FIG. 3a is a schematic diagram of an example scenario provided by an embodiment of the present application;

FIG. 3b is a schematic diagram of another example scenario provided by an embodiment of the present application;

FIG. 3c is a schematic diagram of another example scenario provided by an embodiment of the present application;

FIG. 3d is a schematic diagram of another example scenario provided by an embodiment of the present application;

FIG. 3e is a schematic diagram of another example scenario provided by an embodiment of the present application;

FIG. 3f is a schematic diagram of another example scenario provided by an embodiment of the present application;

FIG. 4 is a schematic flowchart of another directed graph layout method suitable for process editing provided by an embodiment of the present application; and

FIG. 5 is a schematic structural diagram of a directed graph layout apparatus suitable for process editing provided by an embodiment of the present application.

### DETAILED DESCRIPTION OF EMBODIMENTS

In order to enable those skilled in the art to better understand the solutions of the present application, the technical solutions in the embodiments of the present application will be clearly and completely described below with reference to the drawings in the embodiments of the present application. Obviously, the described embodiments are only a part of the embodiments of the present application, rather than all of the embodiments. All other embodiments obtained by those of ordinary skill in the art based on the embodiments in the present application without creative efforts fall within the protection scope of the present application.

The inventors of the present application have found through research that the existing directed graph layout algorithms follow the following four aesthetic principles:

1. Displaying a hierarchical structure in the graph and making all edges point to the same direction as much as possible. In this way, it is helpful to find a directed path and locate start and end nodes.

2. Avoiding visual abnormalities that are irrelevant to the graph, for example, avoiding edge crossings and sharp turns.

3. Using short edges as much as possible, which helps to locate associated nodes and the above second principle.

4. Tending to be symmetric and balanced.

Based on the above aesthetic principles, the existing directed graph layout algorithms may include the following four steps:

S1: finding an optimal node hierarchy assignment using a network simplex algorithm.

S2: determining an order for vertices of the same hierarchy by combining a novel weighting function and an iterative heuristic algorithm for local permutation to reduce wire crossings.

S3: determining optimal node coordinates by constructing and sorting auxiliary graphs.

S4: drawing edges by calculating splines.

Using the above S1-S4, a beautiful directed graph can be drawn quickly. The directed graph can clearly show data flow and has a strong process expression capability, so it is often used to display and edit workflows.

At present, general workflow editing components generally have functions of adding a parent node, a child node, left and right sibling nodes, and deleting a node to a node in the directed graph. In practical applications, after the user triggers the aforementioned operations of adding a parent node, a child node, a left and right sibling node, or deleting a node for a node in the directed graph, the user hopes that the hierarchy and relative position of other nodes in the directed graph will not change. In this way, the user can intuitively see the difference between the edited directed graph and the edited directed graph before.

However, according to the aforementioned description of the directed graph layout algorithm, S1 and S2 of the directed graph layout algorithm will heuristically adjust the hierarchy of the nodes and the order of the nodes between each layer. Therefore, the above directed graph layout algorithm cannot support the user's requirements for the directed graph layout well in the scenario of workflow editing. In order to solve or at least partially solve the above problem, an embodiment of the present application provides a directed graph layout method and apparatus suitable for process editing.

Various non-limiting implementations of the present application will be described in detail below with reference to the drawings.

### Exemplary Method

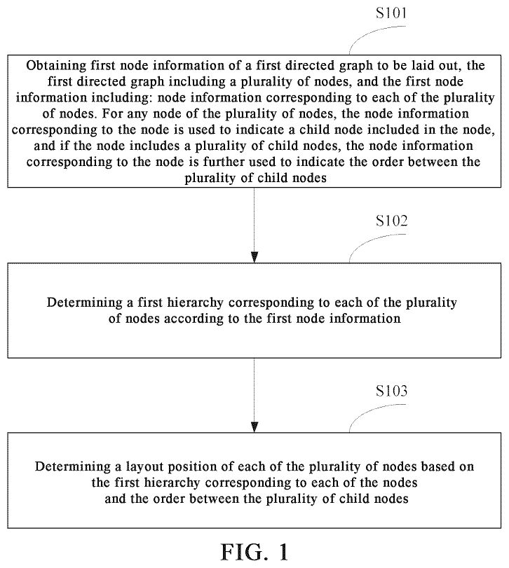

Referring to FIG. 1, which is a schematic flowchart of a directed graph layout method suitable for process editing provided by an embodiment of the present application. The directed graph layout method provided by the embodiment of the present application may be executed by a client or a server, which is not specifically limited by the embodiment of the present application.

In this embodiment, the method may include the following steps, for example: S101-S103.

S101: obtaining first node information of a first directed graph to be laid out, the first directed graph including a plurality of nodes, and the first node information including: node information corresponding to each of the plurality of nodes. Wherein, for any node of the plurality of nodes, the node information corresponding to the node is used to indicate a child node included in the node, and if the node includes a plurality of child nodes, the node information corresponding to the node is further used to indicate an order between the plurality of child nodes.

In an example, in a directed graph editing scenario, the first directed graph to be laid out may be a directed graph obtained after the user triggers a node edit operation for a displayed second directed graph. Of course, the first directed graph may also be a directed graph obtained on the basis of a blank directed graph, which is not specifically limited by the embodiment of the present application.

The form of the second directed graph is not specifically limited by the embodiment of the present application. In an example, the second directed graph may include a root node, and the root node may include at least one child node. In this scenario, the root node may be considered as a first-level node. The child node of the root node may also be called a second-level node, and so on. The second-level node may include a child node, and the child node of the second-level node may be called a third-level node. In another example, the second directed graph may include a plurality of first-level nodes. Similarly, the first-level node may include a corresponding second-level node, and so on. In this scenario, the plurality of first-level nodes cannot be called root nodes, and a directed graph can only have one root node.

In the embodiment of the present application, the first node information of the first directed graph may be used to indicate the parent-child relationship between the plurality of nodes included in the first directed graph.

Specifically, the first node information may include node information corresponding to each of the plurality of nodes. Taking a target node of the plurality of nodes as an example, the node information of the target node may be used to indicate a child node included in the target node. In an example, the node information of the target node may include a mapping relationship between the target node and the child node of the target node. For example, the node information of the target node may be: A: [B], where A represents the target node, and B represents the child node of the target node.

In an example, if the target node includes a plurality of child nodes, the node information of the target node may be used to indicate the order between the plurality of child nodes. In this way, the node information of the target node actually indicates the arrangement order between the child nodes of the same hierarchy. For this case, as an example, the node information of the target node may include a mapping relationship between the target node and a set of child nodes, the set of child nodes including a plurality of child nodes of the target node, and the order of the plurality of child nodes in the set of child nodes being consistent with the order between the plurality of child nodes. For example, the node information of the target node may be: A: [B1, B2, B3], wherein A represents the target node, B1, B2, and B3 represent the child nodes of the target node, and the arrangement order of the three child nodes is: B1→B2→B3.

Regarding the arrangement order of the child nodes, it should be noted that, for a vertically stretched directed graph, the arrangement order B1→B2→B3 may be that B1 is located on the left of B2, and B2 is located on the left of B3. For a horizontally stretched directed graph, the arrangement order B1→B2→B3 may be that B1 is located above B2, and B2 is located above B3.

In an example, the plurality of nodes included in the first directed graph may include a real node and a virtual root node, and the virtual root node is a virtual parent node of a first-level node among the real nodes.

S102: determining a first hierarchy corresponding to each of the plurality of nodes according to the first node information.

In the embodiments of the present application, since the first node information may indicate the child node of each of the plurality of nodes, the first hierarchy corresponding to each of the plurality of nodes may be determined based on the first node information.

As a specific example, the first node information may be traversed from the virtual parent node, to access the nodes included in the first node information, and determine a first hierarchy corresponding to the respective accessed nodes. It is not difficult to understand that a directed graph may include a plurality of branches, and the traversal of the first node information mentioned herein may traverse to respective branches in the first directed graph, so as to access respective nodes on the branches. In the embodiments of the present application, for any branch, the hierarchy of the accessed node is determined based on the order of accessing the nodes on the branch. For example, for branch 1, assuming that the order of accessing the nodes on branch 1 is: virtual root node→node 1→node 2→node 3, it may be determined that the first hierarchy of node 1 is 1, the first hierarchy of node 2 is 1, and the first hierarchy of node 3 is 3, wherein the first hierarchy of the virtual root node may be preset to 0.

In some scenarios, it is considered that the same node may be included between different branches, that is, the same node may belong to a plurality of branches. Taking the first node belonging to a plurality of branches as an example, the first node may be accessed a plurality of times when traversing the first node information. Accordingly, each time the first node is accessed, a hierarchy is determined for the first node. In the embodiments of the present application, if the hierarchy determined for the first node based on the plurality of times of accessing the first node is different, a largest hierarchy for the first node determined based on the plurality of times of accessing may be taken as the first hierarchy of the first node. In this way, the finally determined hierarchy of the first node may conform to an actual situation, and accordingly, the layout of the finally laid out first directed graph is more reasonable. For example:

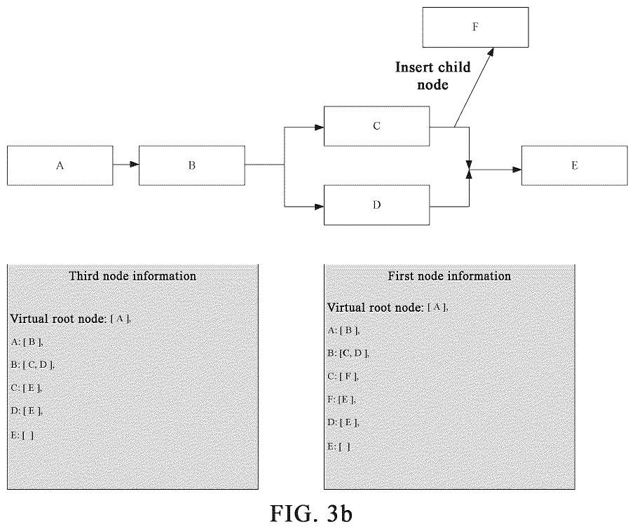

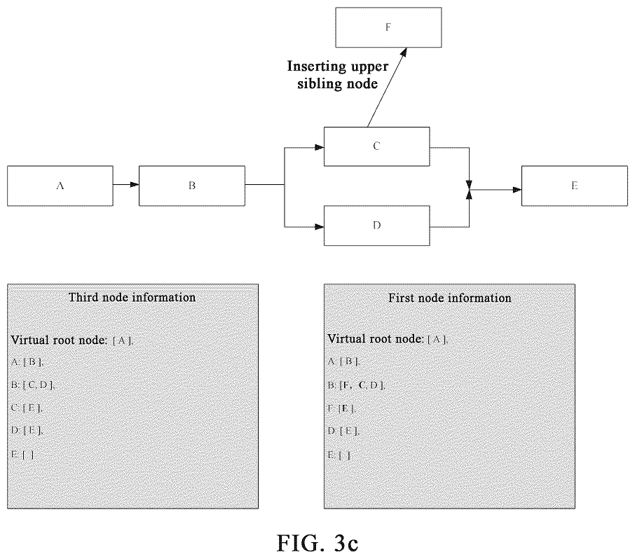

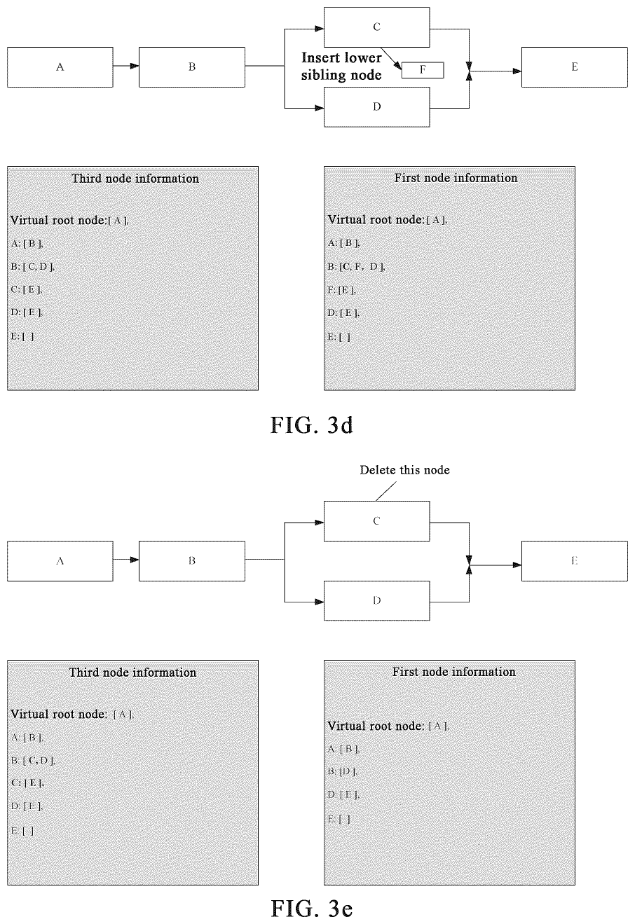

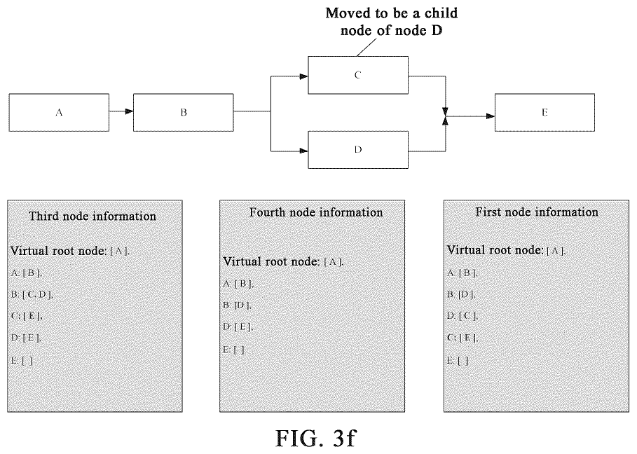

assuming that the first node information corresponds to the first node information shown in FIG. 3a, the order of traversing the first node information is: virtual root node→node A→node B→node C→node F→node E→node D→node E. Therefore, the node E may be accessed twice. The order of accessing the nodes on branch 1 is: virtual root node→node A→node B→node C→node F→node E, and the order of accessing the nodes on branch 2 is: virtual root node→node A→node B→node D→node E. Then, the hierarchy of the node E determined when traversing branch 1 is 5, while the hierarchy of the node E determined when traversing branch 2 is 4, so it may be determined that the first hierarchy of the node E is 5.

S103: determining a layout position of each of the plurality of nodes based on the first hierarchy corresponding to each node and the order between the plurality of child nodes.

S103 may be implemented in various ways, and several possible implementations are introduced below.

In an example, for the plurality of nodes included in the first directed graph, if the first hierarchy of respective parent node of the plurality of nodes and the first hierarchy of a child node corresponding to the parent node are continuous. In other words, for any parent node of the plurality of nodes, the first hierarchy of the parent node is 1 greater than the first hierarchy of each child node corresponding to the parent node. For this case, the layout position of each node may be directly determined based on the first hierarchy corresponding to each node and the first node information.

The layout position mentioned in the embodiments of the present application may be, for example, coordinates.

When “determining the layout position of each node based on the first hierarchy corresponding to each node and the first node information” is specifically implemented, a classic directed graph coordinate assignment algorithm may be used to determine the layout position of each node. Wherein:

The classic directed graph coordinate assignment algorithm will not be described in detail here. Its general principle may be, for example: arranging nodes of the same hierarchy in order, and determining the layout position of the parent node according to the layout position of the nodes of that hierarchy (for example, the layout position of the parent node is centered relative to the layout position of the child node).

In another example, the plurality of nodes included in the first directed graph include a first parent node and a first child node, wherein the first child node is a child node of the first parent node, and correspondingly, the first parent node is a parent node of the first child node. If the first hierarchy of the first parent node and the first hierarchy of the first child node are discontinuous, for example, the first hierarchy of the first parent node is 1, and the first hierarchy of the first child node is 3. For this case, it is considered that since the hierarchy between the first child node and the first parent node is crossed, when drawing a line between the first parent node and the first child node in the directed graph, if the trend of the line is unreasonable, the line may overlap other nodes or other lines in the directed graph. In order to avoid this problem, in this scenario, the layout position of each node in the first directed graph may be determined through the following steps A1-A4.

Step A1: inserting a virtual node between the first parent node and the first child node.

In an example, a plurality of virtual nodes may be inserted between the first parent node and the first child node. The number of virtual nodes inserted between the first parent node and the first child node may be related to the number of hierarchies crossed between the first parent node and the first child node. For example, if the number of hierarchies crossed between the first parent node and the first child node is n (n is an integer greater than or equal to 2), n−1 virtual nodes may be inserted between the first parent node and the first child node. When n−1 is greater than 2, the n−1 virtual nodes are not parallel nodes, and the first parent node, the n−1 virtual nodes, and the first child node may form a branch (or a part of a branch). The virtual node is used to determine the trend of the line segment between the first parent node and the first child node. In an example, the line segment between the first parent node and the first child node passes through the inserted virtual node.

Step A2: updating the first node information based on the virtual node to obtain second node information, wherein the second node information includes node information corresponding to each node and information of the virtual node.

After the virtual node is inserted, the first node information may be updated based on the virtual node to obtain the second node information. Specifically, the node information of the first parent node in the first node information may be modified, and the first child node included in the node information of the first parent node may be modified to a newly added virtual node. In addition, the node information of the newly added virtual node is added to the first node information, thus obtaining the second node information.

Regarding step A1, reference may be made to the example part of Table 2 below, which will not be described in detail here.

Step A3: determining a second hierarchy corresponding to each of the plurality of nodes and a second hierarchy corresponding to the virtual node according to the second node information.

The implementation principle of step A3 is the same as that of S102. Therefore, regarding the specific implementation of step A3, reference may be made to the description of S102 above, and details will not be repeated here.

Step A4: determining the layout position of each node based on the second hierarchy corresponding to each node, the second hierarchy corresponding to the virtual node, and the second node information.

After the virtual node is inserted, for respective nodes included in the second node information, the second hierarchy of the respective nodes and the hierarchy of the child nodes of the respective nodes should be continuous in theory. Therefore, when step A4 is specifically implemented, a classic directed graph coordinate assignment algorithm may be used to determine the layout position of each node based on the second hierarchy corresponding to each node, the second hierarchy corresponding to the virtual node, and the second node information.

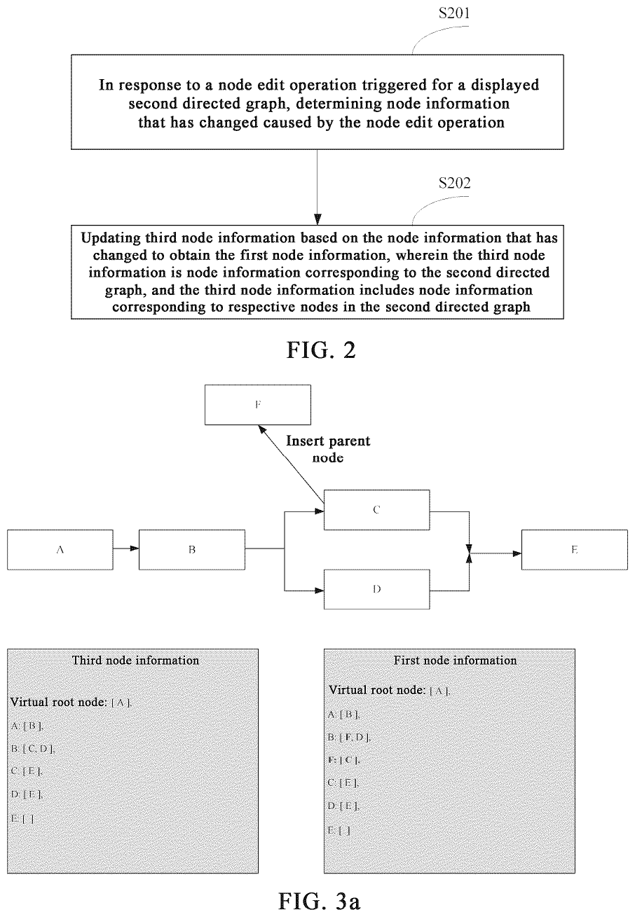

As described above, in the directed graph editing scenario, the first directed graph to be laid out may be a directed graph obtained after the user triggers the node edit operation for the displayed second directed graph. For this case, the first node information may be obtained through S201-S202 shown in FIG. 2. FIG. 2 is a schematic flowchart of a method for obtaining first node information provided by an embodiment of the present application.

S201: in response to a node edit operation triggered for a displayed second directed graph, determining node information that has changed caused by the node edit operation.

S202: updating third node information based on the node information that has changed to obtain the first node information, wherein the third node information is node information corresponding to the second directed graph, and the third node information includes node information corresponding to respective nodes in the second directed graph.

In the embodiments of the present application, it is considered that after the user triggers the node edit operation for the second directed graph, the association relationship between some nodes in the second directed graph may change. Therefore, in the embodiments of the present application, after the user triggers the node edit operation for the second directed graph, the node information that has changed caused by the node edit operation may be determined in response to the node edit operation, and on this basis, the third node information may be updated based on the node information that has changed to obtain the first node information. The third node information is the node information corresponding to the second directed graph, and the third node information includes the node information corresponding to respective nodes in the second directed graph. Regarding the node information of respective nodes, reference may be made to the description of the node information of the nodes in the first node information above, and details will not be repeated here.

In the embodiments of the present application, the node edit operation may include a node insert operation and a node delete operation. The node insert operation may include: a parent node insert operation, a child node insert operation, or a sibling node insert operation.

In a specific example, if the user triggers the parent node insert operation for a second node in the second directed graph, it may be determined that the node information that has changed caused by the parent node insert operation includes: the node information of the parent node of the second node included in the third node information, and the node information of the node inserted by the parent node insert operation. Specifically, the inserted node is a direct child node of the parent node of the second node. Therefore, the second node included in the node information of the parent node of the second node should be replaced with the inserted node. In addition, the node information of the inserted node may include a mapping relationship between the inserted node and the second node, and this mapping information is used to indicate that the second node is a child node of the inserted node.

Correspondingly, when S202 is implemented, the node information of the parent node of the second node included in the third node information may be modified, specifically, the second node in the node information of the parent node of the second node may be replaced with the inserted node; and the node information of the node inserted by the parent node insert operation is added to the third node information to obtain the first node information.

It may be described in conjunction with FIG. 3a, which is a schematic diagram of an example scenario provided by an embodiment of the present application.

FIG. 3a shows the comparison relationship between the third node information and the first node information after a parent node insert operation is triggered for the node C (corresponding to the second node) of the second directed graph, wherein the part of the first node information that is bold and with red characters corresponds to the node information that has changed caused by the aforementioned parent node insert operation.

In another specific example, if the user triggers a child node insert operation for a second node in the second directed graph, it may be determined that the node information that has changed caused by the child node insert operation includes: the node information of the second node included in the third node information, and the node information of the node inserted by the child node insert operation. Specifically, the inserted node is a child node of the second node, so the second child node included in the node information of the second node should be replaced with the inserted node. After the child node insert operation is triggered for the second node, the child node of the second node is the second child node. In addition, the node information of the inserted node may include a mapping relationship between the inserted node and the second child node, and this mapping information is used to indicate that the second child node is a child node of the inserted node.

Correspondingly, when S202 is implemented, the node information of the second node included in the third node information may be modified, specifically, the second child node in the node information of the second node may be replaced with the inserted node; and the node information of the node inserted by the child node insert operation is added to the third node information to obtain the first node information.

It may be described in conjunction with FIG. 3b, which is a schematic diagram of another example scenario provided by an embodiment of the present application.

FIG. 3b shows the comparison relationship between the third node information and the first node information after a child node insert operation is triggered for the node C (corresponding to the second node) of the second directed graph, wherein the part of the first node information that is bold and with red characters corresponds to the node information that has changed caused by the aforementioned child node insert operation.

In another specific example, if the user triggers a sibling node insert operation for a second node in the second directed graph, it may be determined that the node information that has changed caused by the sibling node insert operation includes: the node information of the parent node of the second node included in the third node information, and the node information of the node inserted by the sibling node insert operation. Specifically, the inserted node is a child node of the parent node of the second node, so the inserted node should be added to the node information of the parent node of the second node. In addition, the node information of the inserted node may include a mapping relationship between the inserted node and a child node of the second node, and this mapping information is used to indicate that the child node of the second node is a child node of the inserted node.

Correspondingly, when S202 is implemented, the node information of the parent node of the second node included in the third node information may be modified, specifically, the inserted node may be added to the node information of the parent node of the second node. Specifically, the inserted node may be added to a set of child nodes corresponding to the parent node of the second node, and the position of the inserted node in the set of child nodes is consistent with the position of the node inserted by the user by triggering the sibling node insert operation. In addition, the node information of the node inserted by the sibling node insert operation is added to the third node information to obtain the first node information.

It may be described in conjunction with FIG. 3c and FIG. 3d, which are schematic diagrams of another two example scenarios provided by an embodiment of the present application.

FIG. 3c shows the comparison relationship between the third node information and the first node information after an upper sibling node insert operation is triggered for the node C (corresponding to the second node) of the second directed graph, wherein the part of the first node information that is bold and with red characters corresponds to the node information that has changed caused by the aforementioned sibling node insert operation.

FIG. 3d shows the comparison relationship between the third node information and the first node information after a lower sibling node insert operation is triggered for the node C (corresponding to the second node) of the second directed graph, wherein the part of the first node information that is bold and with red characters corresponds to the node information that has changed caused by the aforementioned sibling node insert operation.

In another specific example, if the user triggers a node delete operation for a third node in the second directed graph, it may be determined that the node information that has changed caused by the node delete operation includes: the node information of the parent node of the third node included in the third node information, and the node information of the third node. Specifically, the node information of the parent node of the third node should no longer include the third node, and the information of the third node should not be retained.

Correspondingly, when S202 is implemented, the node information of the third node included in the third node information may be deleted, and the third node may be deleted from the node information of the parent node of the third node to obtain the first node information. Wherein, deleting the third node from the node information of the parent node of the third node may be deleting the third node from the set of child nodes corresponding to the parent node of the third node.

It may be described in conjunction with FIG. 3e, which is a schematic diagram of another example scenario provided by an embodiment of the present application.

FIG. 3e shows the comparison relationship between the third node information and the first node information after a node delete operation is triggered for the node C (corresponding to the second node) of the second directed graph, wherein the part of the third node information that is bold and with red characters corresponds to the node information that has changed caused by the aforementioned node delete operation.

In another specific example, if the user triggers a position move operation for a fourth node in the second directed graph. Since the position move operation is triggered for the fourth node, the effect is equivalent to deleting the fourth node from the original second directed graph and inserting the fourth node into the second directed graph at the position after moving. Therefore, it may be determined that the node information that has changed caused by the position move operation includes: first change information and second change information. Wherein:

the first change information includes: node information that has changed caused by triggering a delete of the fourth node for the second directed graph. Regarding the first change information, reference may be made to the description of the node information that has changed caused by the node delete operation above, and details will not be repeated here.

The second change information includes: node information that has changed caused by inserting the fourth node into the second directed graph from which the fourth node is deleted. Regarding the inserting the fourth node, it may be inserting the fourth node as a parent node for a certain node, or inserting the fourth node as a child node for a certain node, or inserting the fourth node as a sibling node for a certain node, which may be specifically determined according to the position to which the fourth node is moved.

In an example, if the fourth node is used as a parent node of a certain node, the second change information may be the node information that has changed caused by triggering a parent node insert operation for the certain node. Regarding the node information that has changed caused by the parent node insert operation, reference may be made to the relevant description above, and details will not be repeated here.

In another example, if the fourth node is used as a child node of a certain node, the second change information may be the node information that has changed caused by triggering a child node insert operation for the certain node. Regarding the node information that has changed caused by the child node insert operation, reference may be made to the relevant description above, and details will not be repeated here.

In another example, if the fourth node is used as a sibling node of a certain node, the second change information may be the node information that has changed caused by triggering a sibling node insert operation for the certain node. Regarding the node information that has changed caused by the sibling node insert operation, reference may be made to the relevant description above, and details will not be repeated here.

Correspondingly, when S202 is implemented, the first change information included in the third node information may be deleted to obtain fourth node information, and the fourth node information may be modified based on the second change information to obtain the first node information.

Regarding “modifying the fourth node information based on the second change information”, reference may be made to the description of obtaining the first node information based on the third node information in the above three scenarios of parent node insertion, child node insertion, and sibling node insertion, and details will not be repeated here.

It may be described in conjunction with FIG. 3f, which is a schematic diagram of another example scenario provided by an embodiment of the present application.

FIG. 3f shows the comparison relationship between the third node information, the fourth node information, and the first node information after a position move operation is triggered for the node C (corresponding to the second node) of the second directed graph and the node Cis moved to be a child node of the node D, wherein the part of the third node information that is bold and with red characters corresponds to the aforementioned first change information, and the part of the first node information that is bold and with red characters corresponds to the aforementioned second change information. It can be seen from the above description that, with the solution of the embodiment of the present application, in the directed graph editing scenario (for example, the scenario of displaying and editing a workflow), the relative position between the nodes which is irrelevant to the node edit operation will not change (which is reflected in that most of the node information in the third node information will not change), and accordingly, the hierarchy of the nodes which is irrelevant to the edit operation will not change. Accordingly, the edited directed graph can better meet the user requirements.

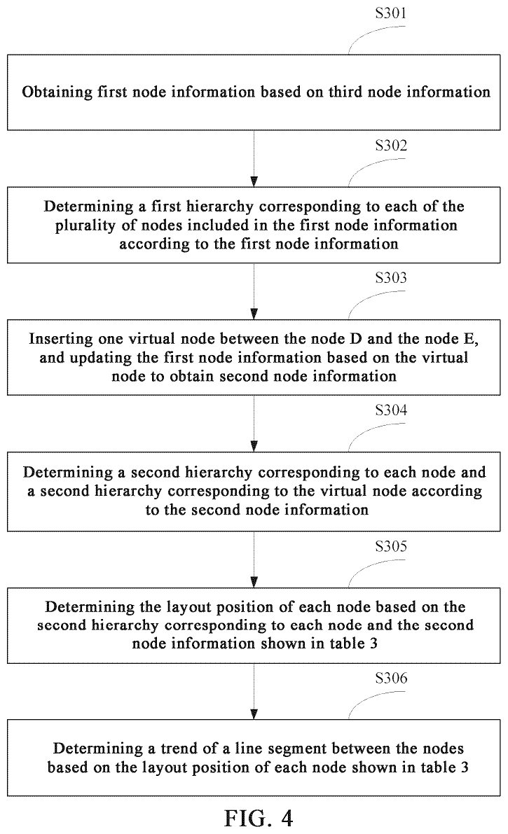

The solution provided by the embodiment of the present application is introduced above. Next, taking the scenario shown in FIG. 3a as an example, the directed graph layout solution provided by the embodiment of the present application will be described in conjunction with S301-S306 shown in FIG. 4. FIG. 4 is a schematic flowchart of another directed graph layout method suitable for process editing provided by an embodiment of the present application.

S301: obtaining first node information based on third node information.

For the specific implementation of S301, reference may be made to the description of FIG. 3a above, and details will not be repeated here.

S302: determining a first hierarchy corresponding to each of the plurality of nodes included in the first node information according to the first node information.

In the scenario shown in FIG. 3a, the traversal goes through two branches, which are:
A->B->F->C->E; and A->B->D->E;

The first hierarchy of the determined nodes may be understood with reference to the following Table 1:

TABLE 1

| Node | First hierarchy |
|---|---|
| A | 1 |
| B | 2 |
| C | 4 |
| D | 3 |
| E | 5 |
| F | 3 |

Since there is a hierarchy cross-domain between the first parent node D and the first child node E, S303 may be performed.

S303: inserting one virtual node between the node D and the node E, and updating the first node information based on the virtual node to obtain second node information.

The first node information and the second node information may be shown in the following Table 2.

TABLE 2

| First node information | Second node information |
|---|---|
| Virtual root node [A], | Virtualroot: [A], |
| A: [B], | A: [B], |
| B: [F, D], | B: [F, D], |
| F: [C], | F: [C], |
| C: [E], | C: [E], |
| D: [E], | D: [virtual node], |
| E: [ ] | virtual node: [E], |
| | E: [ ] |

S304: determining a second hierarchy corresponding to each of the plurality of nodes and a second hierarchy corresponding to the virtual node according to the second node information.

The second hierarchy of the determined nodes may be understood with reference to the following Table 3:

TABLE 3

| Node | Second hierarchy |
|---|---|
| A | 1 |
| B | 2 |
| C | 4 |
| D | 3 |
| Virtual node | 4 |
| E | 5 |
| F | 3 |

S305: determining the layout position of each node based on the second hierarchy corresponding to each node and the second node information shown in Table 3.

The classic directed graph coordinate assignment algorithm may be used to determine the layout position of each node based on the second hierarchy corresponding to each node and the second node information shown in Table 3.

S306: determining a trend of a line segment between the nodes based on the layout position of each node shown in Table 3.

In the embodiments of the present application, after the trend of the line segment between the nodes is determined and the nodes are connected, when displaying the first directed graph, the inserted virtual node may not be displayed. In other words, the layout position of the virtual node is actually used as a control point of the line segment between the first parent node and the first child node that cross the hierarchy, so as to avoid the line segment between the first parent node and the first child node from overlapping other nodes or other lines in the first directed graph.

### Exemplary Device

Based on the method provided in the above embodiments, an embodiment of the present application further provides an apparatus. The apparatus will be introduced below with reference to the drawings.

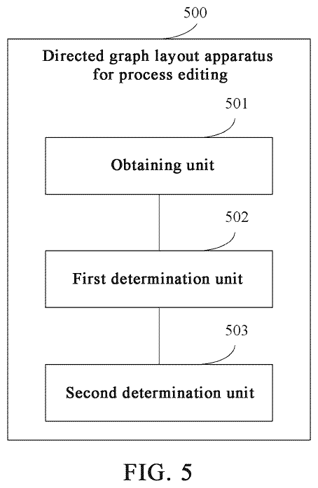

Referring to FIG. 5, which is a schematic structural diagram of a directed graph layout apparatus suitable for process editing provided by an embodiment of the present application. The directed graph layout apparatus 500 suitable for process editing shown in FIG. 5 includes: an obtaining unit 501, a first determination unit 502, and a second determination unit 503.

The obtaining unit 501 is configured to obtain first node information of a first directed graph to be laid out, the first directed graph including a plurality of nodes, and the first node information including: node information corresponding to each of the plurality of nodes, where: for any node of the plurality of nodes, the node information corresponding to the node is used to indicate a child node included in the node, and if the node includes a plurality of child nodes, the node information corresponding to the node is further used to indicate an order between the plurality of child nodes;
the first determination unit 502 is configured to determine a first hierarchy corresponding to each of the plurality of nodes according to the first node information; and
the second determination unit 503 is configured to determine a layout position of each node based on the first hierarchy corresponding to each node and the first node information.

Optionally, the plurality of nodes includes a virtual root node, the virtual root node being used as a virtual parent node of a first-level node, and the first determination unit 502 is configured to:
traverse the first node information from the virtual parent node, to access the nodes included in the first node information, and determine a first hierarchy corresponding to the respective accessed nodes.

Optionally, the plurality of nodes includes a first node, and the apparatus further includes:
a third determination unit, configured to: if the first node is accessed a plurality of times, and the hierarchy determined for the first node based on the plurality of times of accessing the first node is different, take a largest hierarchy for the first node determined based on the plurality of times of accessing as the first hierarchy of the first node.

Optionally, the second determination unit 503 is configured to:
if the first hierarchy of respective parent node of the plurality of nodes and the first hierarchy of a child node corresponding to the parent node are continuous, determine the layout position of each node based on the first hierarchy corresponding to each node and the first node information.

Optionally, the second determination unit 503 is configured to:
if the first hierarchy of a first parent node of the plurality of nodes and the first hierarchy of a first child node of the plurality of nodes are discontinuous, inserting a virtual node between the first parent node and the first child node, wherein the first parent node is a parent node of the first child node, and the virtual node is used to determine a trend of a line segment between the first parent node and the first child node;
updating the first node information based on the virtual node to obtain second node information, wherein the second node information comprises node information respectively corresponding to each node and information of the virtual node;
determining a second hierarchy corresponding to each of the plurality of nodes and a second hierarchy corresponding to the virtual node according to the second node information; and
determining the layout position of each of the plurality of nodes based on the second hierarchy corresponding to each node, the second hierarchy corresponding to the virtual node, and the second node information.

Optionally, the obtaining unit 501 is configured to:
in response to a node edit operation triggered for a displayed second directed graph, determining node information that has changed caused by the node edit operation; and
updating third node information based on the node information that has changed to obtain the first node information, wherein the third node information is node information corresponding to the second directed graph, and the third node information includes node information corresponding to respective nodes in the second directed graph.

Optionally, in response to the node edit operation triggered for the second directed graph, determining the node information that has changed caused by the node edit operation includes:
in response to a parent node insert operation triggered for a second node in the second directed graph, determining that the node information that has changed caused by the parent node insert operation includes: node information of a parent node of the second node included in the third node information, and node information of a node inserted by the parent node insert operation; and
updating the third node information based on the node information that has changed to obtain the first node information includes:
modifying the node information of the parent node of the second node included in the third node information, and adding the node information of the node inserted by the parent node insert operation to the third node information to obtain the first node information.

Optionally, in response to the node edit operation triggered for the second directed graph, determining the node information that has changed caused by the node edit operation includes:
in response to a child node insert operation triggered for a second node in the second directed graph, determining that the node information that has changed caused by the child node insert operation includes: node information of the second node included in the third node information, and node information of a node inserted by the child node insert operation; and
updating the third node information based on the node information that has changed to obtain the first node information includes:
modifying the node information of the second node included in the third node information, and adding the node information of the node inserted by the child node insert operation to the third node information to obtain the first node information.

Optionally, in response to the node edit operation triggered for the second directed graph, determining the node information that has changed caused by the node edit operation includes:
in response to a sibling node insert operation triggered for a second node in the second directed graph, determining that the node information that has changed caused by the sibling node insert operation includes: the node information of the parent node of the second node included in the third node information, and the node information of the node inserted by the sibling node insert operation; and
updating the third node information based on the node information that has changed to obtain the first node information includes:
modifying the node information of the parent node of the second node included in the third node information, and adding the node information of the node inserted by the sibling node insert operation to the third node information to obtain the first node information.

Optionally, in response to the node edit operation triggered for the second directed graph, determining the node information that has changed caused by the node edit operation includes:
in response to a node delete operation triggered for a third node in the second directed graph, determining that the node information that has changed caused by the node delete operation includes: the node information of the parent node of the third node included in the third node information, and the node information of the third node; and
updating the third node information based on the node information that has changed to obtain the first node information includes:
deleting the node information of the third node included in the third node information, and deleting the third node from the node information of the parent node of the third node to obtain the first node information.

Optionally, in response to the node edit operation triggered for the second directed graph, determining the node information that has changed caused by the node edit operation includes:
in response to a position move operation triggered for a fourth node in the second directed graph, determining that the node information that has changed caused by the position move operation includes: first change information and second change information, where the first change information includes: node information that has changed caused by triggering a delete of the fourth node for the second directed graph, and the second change information includes: node information that has changed caused by inserting the fourth node into the second directed graph from which the fourth node is deleted.

Since the apparatus 500 is an apparatus corresponding to the directed graph layout method suitable for process editing provided by the above method embodiments, the specific implementations of respective units of the apparatus 500 are the same as the above method embodiments. Therefore, regarding the specific implementations of respective units of the apparatus 500, reference may be made to the relevant description of the above method embodiments, and details will not be repeated here.

Embodiments of the present application further provide an electronic device, the electronic device including a processor and a memory;
the processor is configured to execute instructions stored in the memory, to cause the device to perform the directed graph layout method suitable for process editing provided by the above method embodiments.

An embodiment of the present application provides a computer-readable storage medium, including instructions, where the instructions instruct a device to perform the directed graph layout method suitable for process editing provided by the above method embodiments.

Embodiments of the present application further provide a computer program product, when the computer program product is run on a computer, causing the computer to perform the directed graph layout method suitable for process editing provided by the above method embodiments.

Those skilled in the art will easily come up with other implementations of the present application after considering the description and practicing the invention disclosed herein. The present application is intended to cover any modifications, uses or adaptations of the present application, which follow the general principles of the present application and include common knowledge or conventional technical means in the technical field not disclosed in the present disclosure. The description and the embodiments are only regarded as exemplary, and the true scope and spirit of the present application are pointed out by the following claims.

It should be understood that the present application is not limited to the precise structure that has been described above and shown in the drawings, and various modifications and changes can be made without departing from its scope. The scope of the present application is only limited by the appended claims.

The above are only preferred embodiments of the present application, and are not intended to limit the present application. Any modifications, equivalent substitutions, improvements, etc. made within the spirit and principles of the present application shall be included in the protection scope of the present application.

I/We claim:

1. A directed graph layout method for process editing, comprising:
obtaining first node information of a first directed graph to be laid out, the first directed graph comprising a plurality of nodes, and the first node information comprising: node information corresponding to each of the plurality of nodes, wherein: for any node of the plurality of nodes, the node information corresponding to the node is used to indicate a child node comprised in the node, and in response to the node comprising a plurality of child nodes, the node information corresponding to the node is further used to indicate an order between the plurality of child nodes;
determining a first hierarchy corresponding to each of the plurality of nodes according to the first node information; and
determining a layout position of each node based on the first hierarchy corresponding to each node and the first node information.

2. The method according to claim 1, wherein the plurality of nodes comprises a virtual root node, the virtual root node being used as a virtual parent node of a first-level node, and determining a first hierarchy corresponding to each of the plurality of nodes according to the first node information comprises:
traversing the first node information from the virtual parent node, to access the nodes comprised in the first node information, and determine a first hierarchy corresponding to the respective accessed nodes.

3. The method according to claim 2, wherein the plurality of nodes comprises a first node, and the method further comprises:
in response to the first node being accessed a plurality of times, and the hierarchy determined for the first node based on the plurality of times of accessing the first node being different, taking a largest hierarchy of hierarchies for the first node determined based on the plurality of times of accessing as the first hierarchy of the first node.

4. The method according to claim 1, wherein determining a layout position of each node based on the first hierarchy corresponding to each node and the first node information comprises:
in response to the first hierarchy of respective parent node of the plurality of nodes and the first hierarchy of a child node corresponding to the parent node being continuous, determining the layout position of each node based on the first hierarchy corresponding to each node and the first node information.

5. The method according to claim 1, wherein determining a layout position of each node based on the first hierarchy corresponding to each node and the first node information comprises:
in response to the first hierarchy of a first parent node and the first hierarchy of a first child node of the plurality of nodes being discontinuous, inserting a virtual node between the first parent node and the first child node, wherein the first parent node is a parent node of the first child node, and the virtual node is used to determine a trend of a line segment between the first parent node and the first child node;
updating the first node information based on the virtual node to obtain second node information, wherein the second node information comprises node information respectively corresponding to each node and information of the virtual node;
determining a second hierarchy corresponding to each of the plurality of nodes and a second hierarchy corresponding to the virtual node according to the second node information; and
determining the layout position of each node based on the second hierarchy corresponding to each node, the second hierarchy corresponding to the virtual node, and the second node information.

6. The method according to claim 1, wherein obtaining the first node information of the first directed graph comprises:
in response to a node edit operation triggered for a displayed second directed graph, determining node information that has changed caused by the node edit operation; and
updating third node information based on the node information that has changed to obtain the first node information, wherein the third node information is node information corresponding to the second directed graph, and the third node information comprises node information corresponding to respective nodes in the second directed graph.

7. The method according to claim 6, wherein in response to the node edit operation triggered for the second directed graph, determining the node information that has changed caused by the node edit operation comprises:
in response to a parent node insert operation triggered for a second node in the second directed graph, determining that the node information that has changed caused by the parent node insert operation comprises: node information of a parent node of the second node comprised in the third node information, and node information of a node inserted by the parent node insert operation; and
updating the third node information based on the node information that has changed to obtain the first node information comprises:
modifying the node information of the parent node of the second node comprised in the third node information, and adding the node information of the node inserted by the parent node insert operation to the third node information to obtain the first node information.

8. The method according to claim 6, wherein in response to the node edit operation triggered for the second directed graph, determining the node information that has changed caused by the node edit operation comprises:
in response to a child node insert operation triggered for a second node in the second directed graph, determining that the node information that has changed caused by the child node insert operation comprises: node information of the second node comprised in the third node information, and node information of a node inserted by the child node insert operation; and
updating the third node information based on the node information that has changed to obtain the first node information comprises:
modifying the node information of the second node comprised in the third node information, and adding the node information of the node inserted by the child node insert operation to the third node information to obtain the first node information.

9. The method according to claim 6, wherein in response to the node edit operation triggered for the second directed graph, determining the node information that has changed caused by the node edit operation comprises:
in response to a sibling node insert operation triggered for a second node in the second directed graph, determining that the node information that has changed caused by the sibling node insert operation comprises: node information of a parent node of the second node comprised in the third node information, and node information of a node inserted by the sibling node insert operation; and
updating the third node information based on the node information that has changed to obtain the first node information comprises:
modifying the node information of the parent node of the second node comprised in the third node information, and adding the node information of the node inserted by the sibling node insert operation to the third node information to obtain the first node information.

10. The method according to claim 6, wherein in response to the node edit operation triggered for the second directed graph, determining the node information that has changed caused by the node edit operation comprises:
in response to a node delete operation triggered for a third node in the second directed graph, determining that the node information that has changed caused by the node delete operation comprises: node information of a parent node of the third node comprised in the third node information, and node information of the third node; and
updating the third node information based on the node information that has changed to obtain the first node information comprises:
deleting the node information of the third node comprised in the third node information, and deleting the third node from the node information of the parent node of the third node to obtain the first node information.

11. The method according to claim 6, wherein in response to the node edit operation triggered for the second directed graph, determining the node information that has changed caused by the node edit operation comprises:
in response to a position move operation triggered for a fourth node in the second directed graph, determining that the node information that has changed caused by the position move operation comprises: first change information and second change information, wherein the first change information comprises: node information that has changed caused by triggering a delete of the fourth node for the second directed graph, and the second change information comprises: node information that has changed caused by inserting the fourth node into the second directed graph from which the fourth node is deleted.

12. An electronic device, comprising a processor and a memory, wherein
the processor is configured to execute instructions stored in the memory, to cause the device to:
obtain first node information of a first directed graph to be laid out, the first directed graph comprising a plurality of nodes, and the first node information comprising: node information corresponding to each of the plurality of nodes, wherein: for any node of the plurality of nodes, the node information corresponding to the node is used to indicate a child node comprised in the node, and in response to the node comprising a plurality of child nodes, the node information corresponding to the node is further used to indicate an order between the plurality of child nodes;
determine a first hierarchy corresponding to each of the plurality of nodes according to the first node information; and
determine a layout position of each node based on the first hierarchy corresponding to each node and the first node information.

13. The device according to claim 12, wherein the plurality of nodes comprises a virtual root node, the virtual root node being used as a virtual parent node of a first-level node, and the instructions causing the device to determine a first hierarchy corresponding to each of the plurality of nodes according to the first node information comprise instructions causing the device to:
traverse the first node information from the virtual parent node, to access the nodes comprised in the first node information, and determine a first hierarchy corresponding to the respective accessed nodes.

14. The device according to claim 13, wherein the plurality of nodes comprises a first node, and the instructions further causes the device to:
in response to the first node being accessed a plurality of times, and the hierarchy determined for the first node based on the plurality of times of accessing the first node being different, take a largest hierarchy of hierarchies for the first node determined based on the plurality of times of accessing as the first hierarchy of the first node.

15. The device according to claim 12, wherein the instructions causing the device to determine a layout position of each node based on the first hierarchy corresponding to each node and the first node information comprise instructions causing the device to:
in response to the first hierarchy of respective parent node of the plurality of nodes and the first hierarchy of a child node corresponding to the parent node being continuous, determine the layout position of each node based on the first hierarchy corresponding to each node and the first node information.

16. The device according to claim 12, wherein the instructions causing the device to determine a layout position of each node based on the first hierarchy corresponding to each node and the first node information comprise instructions causing the device to:
in response to the first hierarchy of a first parent node and the first hierarchy of a first child node of the plurality of nodes being discontinuous, insert a virtual node between the first parent node and the first child node, wherein the first parent node is a parent node of the first child node, and the virtual node is used to determine a trend of a line segment between the first parent node and the first child node;
update the first node information based on the virtual node to obtain second node information, wherein the second node information comprises node information respectively corresponding to each node and information of the virtual node;
determine a second hierarchy corresponding to each of the plurality of nodes and a second hierarchy corresponding to the virtual node according to the second node information; and
determine the layout position of each node based on the second hierarchy corresponding to each node, the second hierarchy corresponding to the virtual node, and the second node information.

17. The device according to claim 12, wherein the instructions causing the device to obtain the first node information of the first directed graph comprises instructions causing the device to:
in response to a node edit operation triggered for a displayed second directed graph, determine node information that has changed caused by the node edit operation; and
update third node information based on the node information that has changed to obtain the first node information, wherein the third node information is node information corresponding to the second directed graph, and the third node information comprises node information corresponding to respective nodes in the second directed graph.

18. The device according to claim 17, wherein the instructions causing the device to in response to the node edit operation triggered for the second directed graph, determine the node information that has changed caused by the node edit operation comprises instructions causing the device to:
in response to a parent node insert operation triggered for a second node in the second directed graph, determine that the node information that has changed caused by the parent node insert operation comprises: node information of a parent node of the second node comprised in the third node information, and node information of a node inserted by the parent node insert operation; and
the instructions causing the device to update the third node information based on the node information that has changed to obtain the first node information comprise instructions causing the device to:
modify the node information of the parent node of the second node comprised in the third node information, and add the node information of the node inserted by the parent node insert operation to the third node information to obtain the first node information.

19. The device according to claim 17, wherein the instructions causing the device to in response to the node edit operation triggered for the second directed graph, determining the node information that has changed caused by the node edit operation comprise instructions causing the device to:
in response to a child node insert operation triggered for a second node in the second directed graph, determine that the node information that has changed caused by the child node insert operation comprises: node information of the second node comprised in the third node information, and node information of a node inserted by the child node insert operation; and
the instructions causing the device to update the third node information based on the node information that has changed to obtain the first node information comprises instructions causing the device to:
modify the node information of the second node comprised in the third node information, and add the node information of the node inserted by the child node insert operation to the third node information to obtain the first node information.

20. A non-transitory computer-readable storage medium, comprising instructions, wherein the instructions cause a device to:
obtain first node information of a first directed graph to be laid out, the first directed graph comprising a plurality of nodes, and the first node information comprising: node information corresponding to each of the plurality of nodes, wherein: for any node of the plurality of nodes, the node information corresponding to the node is used to indicate a child node comprised in the node, and in response to the node comprising a plurality of child nodes, the node information corresponding to the node is further used to indicate an order between the plurality of child nodes;
determine a first hierarchy corresponding to each of the plurality of nodes according to the first node information; and
determine a layout position of each node based on the first hierarchy corresponding to each node and the first node information.
